(19) United States
(12) Patent Application Publication
(10) Pub. No.: US 2010/0125493 A1
(43) Pub. Date: May 20, 2010

(54) Common Purchase System and Method Having Circular Membership System for Congratulation and Condolence

(76) Inventor: Byung-Ho Kim, Busan (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/431,499

(22) Filed: Apr. 28, 2009

(30) Foreign Application Priority Data
Nov. 20, 2008 (KR) 10-2008-0115713

(51) Int. Cl. G06Q 30/00; G06F 15/16; G06Q 20/00; G06Q 50/00

(52) U.S. Cl. 705/14.16; 705/26; 709/206

(57) ABSTRACT

A common purchase system and its method having circular membership system for congratulation and condolence are provided. A plurality of member terminals requests for an application of the congratulations and condolences membership, requests an application for registration as a beneficiary and requests cooperative purchase of daily necessaries of life via a communication network. A plurality of terminals of cooperative enterprises receives product information for which cooperative purchase is requested in the plurality of member terminals, delivers a concerned product, and then provides a delivery result information about the product which is bought according to a cooperative purchase request.

### TECHNICAL FIELD

The present invention is related to a common purchase system and method having circular membership system for congratulation and condolence, and in particular, is related to a common purchase system and method having circular membership system for congratulation and condolence in which consists of a multistage membership in which frequency of payment of a maintenance allowance and a recommendation allowance is limited, operates the goods desired by the members in a cooperative purchase manner for generating a sales profit, and distributes the sales profit to the members.

### BACKGROUND ART

Generally, in a sales method of a multistage type, a membership network of a pyramid type is formed in which new members are increased by arranging a new salesman under a lower level of a recommending salesman according to recommendation of the recommending salesman and a predetermined ratio of the sales profit acquired when the lower salesman sells specific products to the consumers is distributed to the salesman of the upper level in a roll-up manner. In addition the above sales method, there is a method in which the lower salesmen are divided into two groups and the upper level salesmen give compensation money to the group which accomplishes the poor sales accounts.

However, the above sales method has a problem that the sales profit are concentrated on the upper level salesmen even if the salesmen of the lower level achieve superior sales accomplishments, and the salesmen of the lower level should collect more recommending members so that they can advance into the upper level where much more profits can be obtained. But, as the level goes down to the lower level, since it is difficult to collect the new recommendation members, there was a trouble that the very excessive burden was imposed on the sales men of the lower level. Further, in the above sales method, since only the products of the designated specific kinds were sold, there was a case that the members was forced to sell the products which actual consumers do not want to buy in order to compensate a heavy sales accomplishments. A side effect was generated that the structural problems of the multistage sales were passed on to the consumers by setting the prices of the sold products exorbitantly high in order to solve the above problems. The consumers want to buy the goods of a high quality which are essential for their daily life, and they recommend the excellent goods to neighboring persons. But, they want to do an auxiliary job which can be performed in a home unlike the conventional multistage sales. In order to meet these demands, a common purchase system using the Internet is now operated, but it was not possible to provide actual sales profit to the consumers. In addition, the general consumers want a system in which they can receive the agent services for congratulation and condolence of high quality while coping with congratulation and condolence events, and membership fees are not so burdensome. But, a conventional method for providing agent services for congratulation and condolence only acts as an insurance for coping with congratulation and condolence which may be take place in the future, and there were unwanted membership fees paid to a salesman for a predetermined period. Further, in a conventional system or a sales method, various kinds of consumer's demand as mentioned above were not satisfied.

### DISCLOSURE

[Technical Problem]

The present invention is devised in order to solve these conventional problems of the goods, and the object of it is to provide a common purchase system and a method having circular membership system for congratulation and condolence which is organized as a multistage membership network and can provide the profits same as those of the upper members to the lower members without giving any damage to the lower members and concentrating the profits on the upper members.

Another object of the present invention is to provide a common purchase system and a method having circular membership system for congratulation and condolence which is operated as the most suitable system so that all the members can buy indispensable best products since all the members become consumers, but a cooperative purchase, a cooperative sale, and a cooperative distribution system are executed, and the profits are generated even if the members buy only essential products

Still another object of the present invention is to provide a common purchase system and a method having circular membership system for congratulation and condolence which enables the members to cope with congratulation and condolence which may be take place in the future, there are no burdens in terms of the membership fee, and satisfies various kinds of consumer's demand by combining effective cooperative purchase method and equal circular membership system.

[Technical Solution]

In order to accomplish the above objects, in a common purchase system having circular membership system for congratulation and condolence according to the first aspect of the present invention which organizes members as a circular membership system, and buys products desired by the members in a cooperative manner, the common purchase system is characterized in that it comprises a plurality of member terminals for requesting for an application of the congratulations and condolences membership, requesting an application for registration as a beneficiary and requesting cooperative purchase of daily necessaries of life via a communication network; a plurality of terminals of cooperative enterprises which receives product information for which cooperative purchase is requested in the plurality of member terminals, delivers a concerned product, and then provides a delivery result information about the product which is bought according to a cooperative purchase request; a common management server which responds to a request for registration as a beneficiary and an admission request as a membership of a congratulation and condolence group from the plurality of member terminals, arranges the admitted members according to an admission order by employing membership network structure of a pyramid type in which two lower members are arranged under the upper level member, and registers them as beneficiaries, pays a maintenance allowance corresponding to a designated frequency to the members related to the upper level designated for each member, pays a recommendation allowance corresponding to a designated frequency to recommendation members, generates sales profit by enabling the members to buy the goods of the cooperative enterprises together and then distributes the generated sales profit to each member according to purchase accomplishments obtained based on the delivery result information outputted from plurality of terminals of cooperative enterprises, and notifies the concerned cooperative enterprises of congratulation and condolence of the members when they are received; and a communication network connecting the common management server, the plurality of member terminals, and the plurality of terminals of cooperative enterprises.

According to a common purchase method having circular membership system for congratulation and condolence according to another aspect of the present invention, in a common purchase system having circular membership system for congratulation and condolence which organizes members as a circular membership system and buys products desired by the members in a cooperative manner,

the common purchase method having circular membership system for congratulation and condolence using a system including a member terminal for requesting for an application of the congratulations and condolences membership, requesting an application for registration as a beneficiary and requesting cooperative purchase of daily necessaries of life via a communication network; a terminal of a cooperative enterprise which receives product information for which cooperative purchase is requested in the member terminal, delivers a concerned product, and then provides a delivery result information about the product which is bought according to a cooperative purchase request; and a common management server which responds to a request for registration as a beneficiary and an admission request as a membership of a congratulation and condolence group from the member terminal, arranges the admitted members according to an admission order by employing membership network structure of a pyramid type in which two lower members are arranged under the upper level member, and registers them as beneficiaries, pays a maintenance allowance corresponding to a designated frequency to the members related to the upper level designated for each member, pays a recommendation allowance corresponding to a designated frequency to recommendation members, generates sales profit by enabling the members to buy the goods of the cooperative enterprises together and then distributes the generated sales profit to each member according to purchase accomplishments obtained based on the delivery result information outputted from plurality of terminals of cooperative enterprises, and notifies the concerned cooperative enterprises of congratulation and condolence related to the members when they are received,

is characterized in that it comprises a step for collecting members as a beneficiary as a precondition of admission and for establishing a membership network by associating members ranging from the upper level to a lower level according to an admission order; a step for creating a member information database including information of associated members or recommending members from the established membership network to a designated level; a step for generating a sales profit by enabling members to buy the products requested by the members via the cooperative enterprises, and accumulating scores corresponding to a purchase amount for a member who bought the products; a step for distributing the generated sales profit to the members according to the accumulated scores and for paying an allowance to the associated members or the recommending members stored in the member information database of each member; and a step for notifying concerned cooperative enterprises of congratulation and condolence related to the members when they are received.

[Advantageous Effects]

According to the present invention, since a maintenance allowance to be paid and a maintenance allowance to be received do not exceed a predetermined amount of money, equal chances are provided to all the members while profits are not concentrated on the upper members, and an expansion speed of a membership network can be accelerated since the present invention is a circular membership system in which many accounts are allowed for each member. Especially, since the limit generated when one account is registered for one member can be overcome, equal benefits are provided to the members at different timings, and one account can be composed of consumption of a minimum unit, but the present invention is the best system which is legally and rationally established and can overcome consumption limit even by some efforts. Further, it is possible to secure an account only by introducing the system of the present invention to other persons without consuming the products, and it is also possible to increase the account by collecting scrap materials. In addition, according to the present invention, it is possible to confirm the purchase accomplishments of a member via a computer system, and to buy the products of high quality at cheap prices in a cooperative manner. The present invention is a system in which the best efficiency can be obtained through a cooperative sale by applying the fusion/complex marketing which integrates a visit sale, a home shopping, a network, a communication sale, and a counter sale for the first time in the world to all the items, and proceeds are distributed commonly according to all accomplishments through transparency and reliable distribution and giving money in charity. That is, since sales profit can be acquired equally while a member buys only the indispensable ones among the registered products, there is not a bad practice at all that a member is forced to buy unnecessary products. A consumer can buy the best products desired by the consumer at the cheapest price. Since the fusion/complex marketing minimizes costs (delivery, marketing, and other expenses) incurred while a product is transferred to a consumer without distributing profits (profiteering) by setting the price of a product tremendously upper level than an actual price like a multistage system, and maximizes the sales account, the consumer can buy a more reliable product at a cheap price and benefits are provided. Further, according to the present invention, only the members buy the essential daily necessaries and use them, but the incomes much upper level than the fees for coping with congratulation and condolence which may be take place in the future are provided to all the members.

### DESCRIPTION OF THE DRAWINGS

The above and other aspects, features and advantages of the present invention will be more apparent from the following detailed description taken in conjunction with the accompanying drawings, in which:

FIG. 1 is a diagram showing a block structure of a common purchase system having circular membership system for congratulation and condolence according to an embodiment of the present invention.

FIG. 2 is a diagram showing a hierarchical membership network structure according to an embodiment of the present invention.

FIG. 3 is a diagram showing a structure of a member information data according to an embodiment of the present invention.

FIG. 4 is a sales flow chart illustrating a common purchase method having circular membership system for congratulation and condolence according to an embodiment of the present invention.

FIG. 5 is a diagram explaining the operation processes of a common purchase system and its method having circular membership system for congratulation and condolence according to an embodiment of the present invention.

FIG. 6 is a flow chart illustrating a payment method of a sales profit and an allowance according to an embodiment of the present invention.

### BEST MODE FOR CARRYING OUT THE INVENTION

### Mode for Invention

Below, the preferred embodiment of the present invention will be explained in detail with referring to the attached drawings.

Below, the preferred embodiment of the present invention will be explained in detail with referring to the attached drawings so that a person having a common knowledge in the related art can implement easily. It is to be noted that the reference numbers denoted in a structure or operations in the attached drawings are also used as far as possible when denoting same structure or operations in other drawings. Further, when explaining the present invention as below, if it is judged that specific explanation about widely-known functions or structures make the gist of the present invention unnecessarily unclear, the explanation will be omitted.

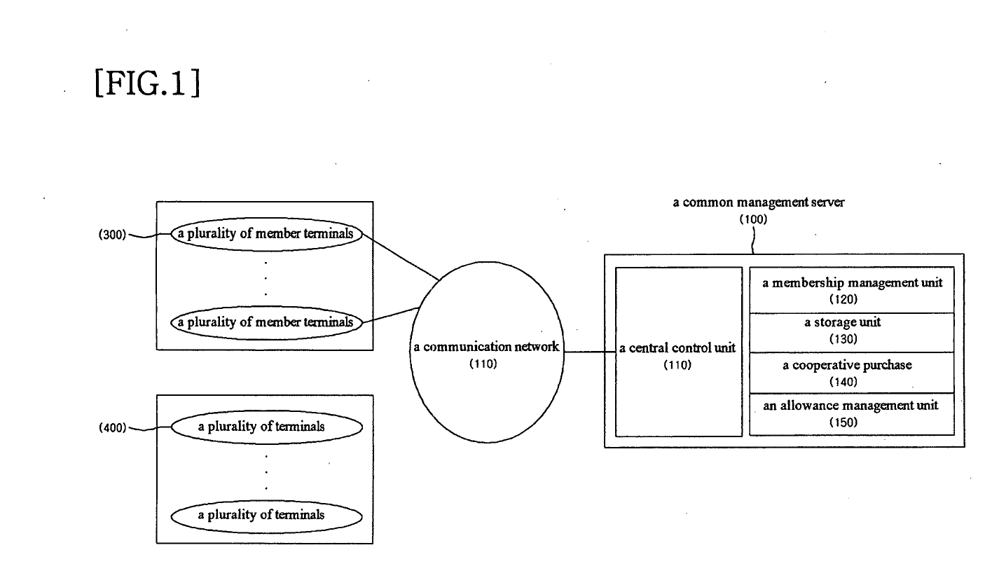

FIG. 1 is a diagram illustrating a block structure of a common purchase system having circular membership system for congratulation and condolence according to an embodiment of the present invention.

Referring to FIG. 1, a cooperative purchase system according to the present invention includes a plurality of member terminals 300, a plurality of terminals 400 of cooperative enterprises, a common management server 100 and a communication network 200.

By using with the plurality of member terminals 300, an user requests an application for admission as a member of congratulations and condolences group by paying the congratulations and condolences fees of the designated number while subscribing to a web site established by a cooperative purchase system and then, requesting an application for registration as a beneficiary; and a member requesting purchase of daily necessaries of life requests a connection via a communication network. All kinds of daily necessaries ranging from the cradle to the grave can be enumerated as the goods to which the congratulations and condolences fees can be applied. In particular, the mutual assistance of the present invention is an event service acting as an intermediary between a product which is developed as a general mutual assistance of life by paraphrasing our beautiful and traditional exchange of work in a modem fashion, and products of other companies. Among the services, a mutual assistance of life requires a tidy sum of money. As examples, there are dental implants, cosmetic operations, purchase of furnitures, jewelry, travel (a pilgrimage to the Holy Land), training for foreign language, visit to a motherland by the Korean residents abroad, private tutoring, mixing with other people, a leisure use, cost of travel, various kinds of events, marriages, funeral ceremonies, admission to sanatorium, purchase of medical equipments and etc.

The plurality of terminals 400 of cooperative enterprises provides information about the commodities which the cooperative enterprises registered to a web site established by a cooperative purchase system want to buy, and receives information about the cooperative purchase of requested goods via a communication network.

The plurality of terminals 400 of cooperative enterprises provides a delivery result information about the goods which were bought according to a cooperative purchase request after delivering the concerned goods.

The common management server 100 responds to a request for registration as a beneficiary and a admission request as a membership of a congratulation and condolence group from the plurality of member terminals 300, arranges the subscribed members according to the order of admission registers them as beneficiaries by employing membership network 10 of a pyramid type in which two lower member are arranged under the upper level member, pays a maintenance allowance corresponding to a designated frequency to the members related to the upper level designated for each member, pays a recommendation allowance corresponding to a designated frequency to the recommendation members, generates sales profit by enabling the members to buy the goods of the cooperative enterprises together and then distributes the generated sales profit to each member according to purchase accomplishments obtained based on the delivery result information outputted from plurality of terminals 400 of cooperative enterprises, and notifies the concerned cooperative enterprises of congratulation and condolence of the members when they are received.

The common management server 100 includes a storage unit 130 of membership information, a membership management unit 120, a cooperative purchase management unit 140, a allowance management unit 150, and a central control unit 110.

The storage unit 130 of member information stores a membership information data 20 of each member, which consists of an identification number 21 of a registered member, a member admission information 22, a payment breakdown 23 of fees of congratulation and condolence, an accumulated monthly score 24 obtained when a member buys the goods, information 25 of the upper level member about concerned members included in the range of the upper level designated as information about the upper level member of the member, a recommendation member information 26 about a member who recommended admission of the member, a receiving amount 27 of a monthly maintenance allowance which is received from the accounts under the member, a received money 28 of a monthly sales allowance which is received according to the accumulated monthly score 24, and a member information 29 about a member who is recommended by the member and subscribed as a membership.

The membership management unit 120 is a membership network structure 10 of a pyramid type in which two lower members are arranged under one upper level member, forms a membership network structure 10 of a pyramid type by arranging the subscribed members sequentially in a lower echelon of the membership network structure 10 of a pyramid type according to the subscription order, an identification number is provided to a new member if a admission request of the new member is made, stores the identification numbers of the members arranged until a designated upper level among the upper members related to of the new member, and an identification number of the member who recommended the newly subscribed member in a membership information data 20 corresponding to the newly subscribed member, stores an identification number of a recommending member in the membership information data 20 of the recommended member, and notifies the concerned cooperative enterprises of congratulation and condolence of the members when they are received from the plurality of member terminals 300.

The cooperative purchase management unit 140 provides information about the goods which are to be sold to the members, provides a purchasing information including the purchasing commodities, the quantity, and the addresses of the members who requested purchase of commodity according to the purchase request of a member to the terminals 400 of the concerned cooperative enterprises, checks settlement of prices according to purchasing of the goods, and stores amount of the purchased goods and a score alloted to the quantity in the membership information data 20 of a member who bought the goods.

On a settlement date of every month, the allowance management unit 150 pays a maintenance allowance to the upper level member corresponding to each member until a predetermined frequency only with respect to the members who pay the congratulation and condolence fees, pays a recommendation compensation to a recommending member of each members until a designated frequency, and pays sales allowance to each member according to the accumulated monthly scores of each member.

The central control unit 110 transmits the received admission information to the membership management unit 120 if a membership admission is requested so that a membership network structure can be organized, stores information of each member in the storage unit 130 of member information according to the organized membership network structure 10, transmits a piece of purchase information to the cooperative purchase management unit 140 if purchase of the goods is requested by a member so that the member can buy the desired goods from the cooperative enterprises, and enables settlement of the allowance management unit 150 to be performed via a communication network.

The communication network 200 connects the common management server 100, the plurality of member terminals 300, and the plurality of terminals 400 of cooperative enterprises.

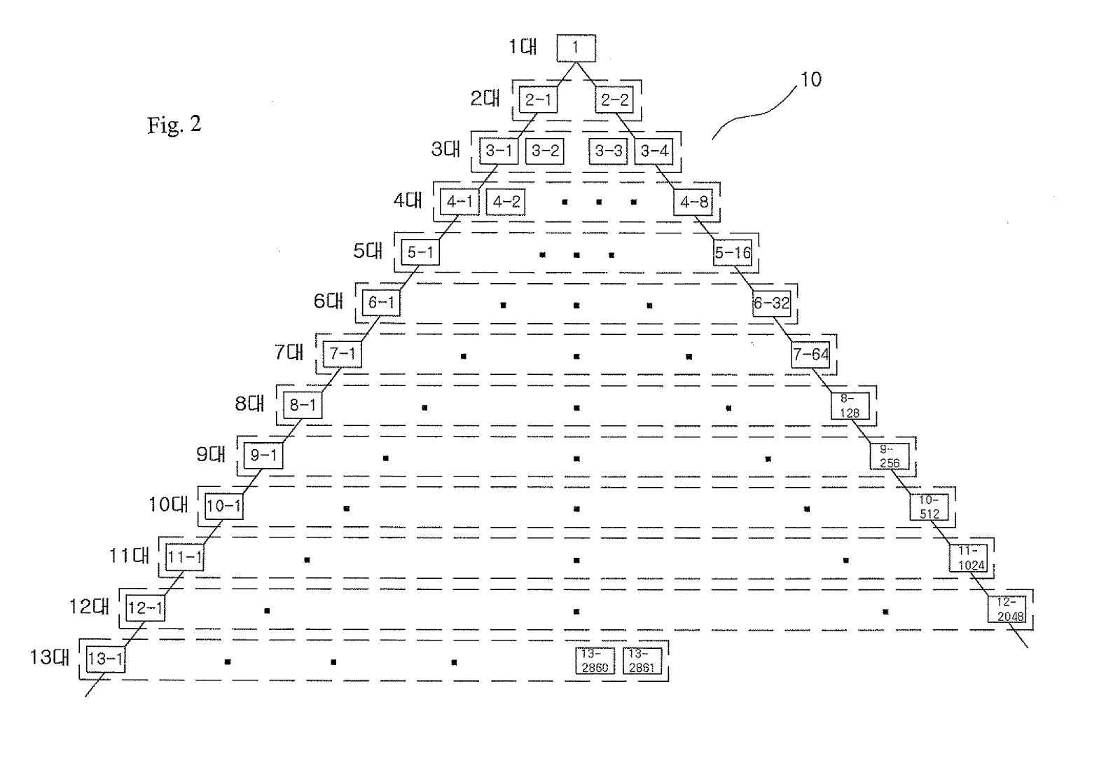

The method for forming the membership network structure 10 in the membership management unit 120 as new members subscribe to the cooperative purchase system incessantly will be explained in detail with referring to FIG. 2.

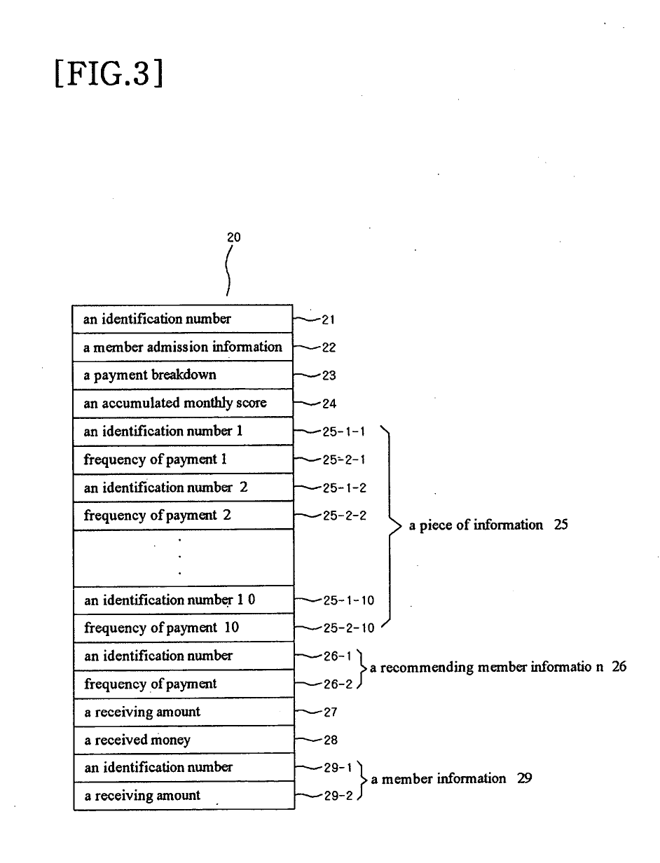

Further, the membership information data 20 of each member stored in the storage unit 130 of member information will be explained in detail with referring to FIG. 3. The settlement method of the allowance management unit 150 which is executed for each member according to the membership information data 20 of each member will also be explained in detail with referring to the membership network structure 10 of FIG. 2.

FIG. 2 is a diagram showing a hierarchical membership network structure 10 of a stepwise type formed by the membership management unit 120 in a common purchase method having circular membership system for congratulation and condolence according to an embodiment of the present invention. According to FIG. 2, the membership network structure 10 of a cooperative purchase system operated based on the congratulation and condolence membership of a stepwise circulation type according to an embodiment of the present invention consists of a membership network of a pyramid type arranging two lower members under one upper level member. To be more specific, the first level member 1 forming a highest rank, the second level members 2-1, 2-2 who are two lower members related to the first level member 1, the third level members 3-1, 3-2 and 3-3, 3-4 who are two lower members related to each of the second level members 2-1, 2-2 are organized. In this way, the fourth level member in which two members are related to each of the third level members 3-1, 3-2, 3-3, 3-4 so that a lower level including eight members can be formed, and etc. are organized sequentially as a pyramid shape. Further, the congratulation and condolence membership of a circulation type according to an embodiment of the present invention is characterized in that a membership network of a pyramid type can be organized by sequentially arranging the members who request an admission to the system according to from a high level to a low level, from a left side to a right side in each level, and an admission order. For example, in FIG. 2, under the state that the first and the 12th levels are completed and 2861 members of 13th level including the members (13-2861) who are now finally admitted are registered, if an admission request of a new member is made, the new member is registered as a member of (13-2862) who is not illustrated beside the last member (13-2861). Further, the member registered in the membership network structure 10 according to the present invention will have an account for paying the congratulation and condolence fees, and paying or receiving allowances. If the same member subscribes to the system repeatedly, other identification number is issued and the same member will be arranged in the membership network structure 10 like the admission method of a new member. Thus, the same member can have many accounts.

All the members are registered as a beneficiary and are also registered in the common management server according to a registration order. The registration designates one account as a minimum unit and limits the vested rights by defining the number of registration as 24 times. A plurality of independent accounts can be opened by allowing a repetitious consumption concept and an economic system of a free market and limitation of the lower line can be solved through many independent accounts and a circulation engine. One account unit is divided into 10 scores and consumption of one score is set as 1,000 won which is a profit of consumption. If one purchase does not satisfy 10 scores, the score is registered in an accumulated manner until 10 scores are reached. A step for complementing the shortcomings of a existing network and a multistage system by limiting a registration number of a registered position to 24 times is employed in a method for solving the differential benefits given to the previously admitted members which may be generated in a pyramid system while increasing the profit efficiency. That is, even if the same member subscribes repeatedly, the method for arranging in the membership network structure 10 is executed according to the same registration order like the order mentioned above.

FIG. 3 is a structure diagram of the membership information data 20 stored in the storage unit 130 of member information in a common purchase system having circular membership system for congratulation and condolence according to an embodiment of the present invention.

In FIG. 3, the membership information data 20 in the storage unit 130 of member information consists of an identification number 21 of a registered member; a member admission information 22 including the bank account of the member and the address to which mails can be sent; the payment details 23 of the congratulation and condolence fees in which breakdown of the congratulation and condolence fees which the member has paid every month is stored; a accumulated monthly score 24 which is given when the member buys the goods; information 25 of the upper level member including the identification number (25-1-1˜25-1-10) of 10 members of the upper level to whom the member must pay a maintenance allowance, and frequency (25-2-1˜25-2-10) of payment indicating frequency of the maintenance allowance paid to the upper 10 members; information 26 of a recommending member including an identification number (26-1) of a recommending member which is a registration information of other member recommending admission of the member, and frequency (26-2) of a recommendation allowance paid to the recommending member; a receiving amount 27 of a monthly maintenance allowance which is received from the accounts registered under the member; a receiving amount 28 of a monthly sales allowance which is received according to the accumulated monthly scores obtained by purchase of the member; a recommending member information 29 including an identification number (29-1) of a recommending person which is information of a member who is recommended and admitted by the member, and a receiving amount (29-2) of a monthly recommendation allowance received from the recommending member.

The information 25 of the upper level member includes an identification number (25-1-1˜25-1-10) of the upper members of the upper 10th level, and frequency (25-2-1˜25-2-10) of payment indicating frequency of the maintenance allowance paid to the upper members of the upper 10th level. For example, referring to the membership network structure 10 of FIG. 2, if I am positioned in 12-1 of 12th level of the membership network structure 10, the identification numbers of the members positioned in 2-1, 3-1, 4-1, 5-1, 6-1, 7-1, 8-1, 9-1, 10-1 and 11-1 are entered into the identification number (25-1-1˜25-1-10) of the upper members, and frequency of the maintenance allowances which have been paid to each of the members every month are stored in frequency (25-2-1˜25-2-10) of payment of the upper members.

FIG. 3 is a case that the associated members of the upper level to whom the maintenance allowances should be paid are designated as the upper 10th level. For explaining the embodiment according to the present invention clearly, assuming that frequency of a maintenance allowance paid to the upper members is limited to 24 times, and a recommendation allowance paid to a recommending member registered at a time of a member admission is limited 24 times, explanation is made as below.

Referring to the arrangement method of the membership network structure 10 of FIG. 2, since the number of the members increase by a multiple of 2 as the level goes down by one level, the number of the members in the lower 10th level related to myself is 2046 members, which is the total sum of 2, 4, 8, 16, 32, 64, 128, 256, 512, 1024. Further, it is natural that the number of the members in the upper level 10th level related to myself is 10. In this way, the maintenance allowance received and paid among the members in the upper level or lower 10th level related to a member himself is transferred from the his own account by the allowance management unit 150 on every settlement date until frequency of payments made to each of the upper members in the 10th level reaches 24 times by referring to frequency (25-2-1˜25-2-10) of payment of the upper level member.

Therefore, the receiving amount 27 of a monthly maintenance allowance of himself receives the maintenance allowance from each of 2046 members in the lower 10th level related to himself by the allowance management unit 150, and frequency when the maintenance allowance is received from each member is limited to 24 times.

In the method for enabling the allowance management unit 150 to pay the recommendation allowance to a recommending person registered at a time of a member admission, the recommendation allowance is paid to the recommending person of himself on every settlement date, and frequency of payment is checked whenever the recommendation allowance is paid. If frequency reaches 24 times, the recommendation allowance is not paid to the recommending person any more from the next settlement date. In a case that he subscribes to the system voluntarily without any recommendations, since a recommending person is not registered, the recommendation allowance is not paid.

In the method for enabling the allowance management unit 150 to pay the monthly sales allowance to the members, the scores are issued to the members whenever the members buy the goods of the cooperative enterprises via the common management server, and then the scores are accumulated for every month. On a settlement date, the sales allowance is paid to the members according to the accumulated monthly score 24 of the members.

In the present invention implemented as above, the allowance which a member himself pays or receives on every settlement date includes a maintenance allowance paid to each of 10 members in the upper 10th level related to himself, a maintenance allowance received from each of the lower 2046 members in the lower 10th level related to himself, a recommendation allowance paid to a member who recommends himself, a recommendation allowance received from the member who a member himself recommends, and a sales allowance received according to the purchased goods.

Therefore, the present invention is characterized in that a paid maintenance allowance is limited to 10 members of the upper level; a paid recommendation maintenance allowance is limited only to a member recommending himself, or the allowance to be paid is not burdensome because frequency of the paid maintenance allowance and the paid recommendation maintenance is limited 24 times; and the received allowance is relatively larger than the paid allowance since the received maintenance allowance is received from 2046 members and the received recommendation maintenance depends on his own efforts even if the received maintenance allowance and the received recommendation maintenance is limited to 24 times. Further, much more gains are obtained in addition to retrieving the congratulations and condolences fees which are paid every month. Further, according to the present invention, since repeated admission can be possible and a circulation structure having many accounts which can be bought once again, profit bias phenomenon is not generated unlike a conventional multistage sales method which are beneficial only for the upper members, and there is a chance that an equal profit distribution can be made to all the members.

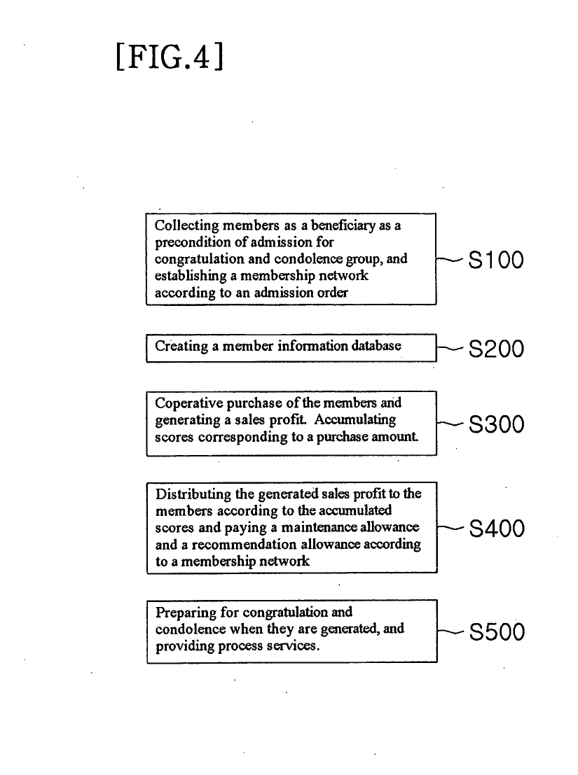

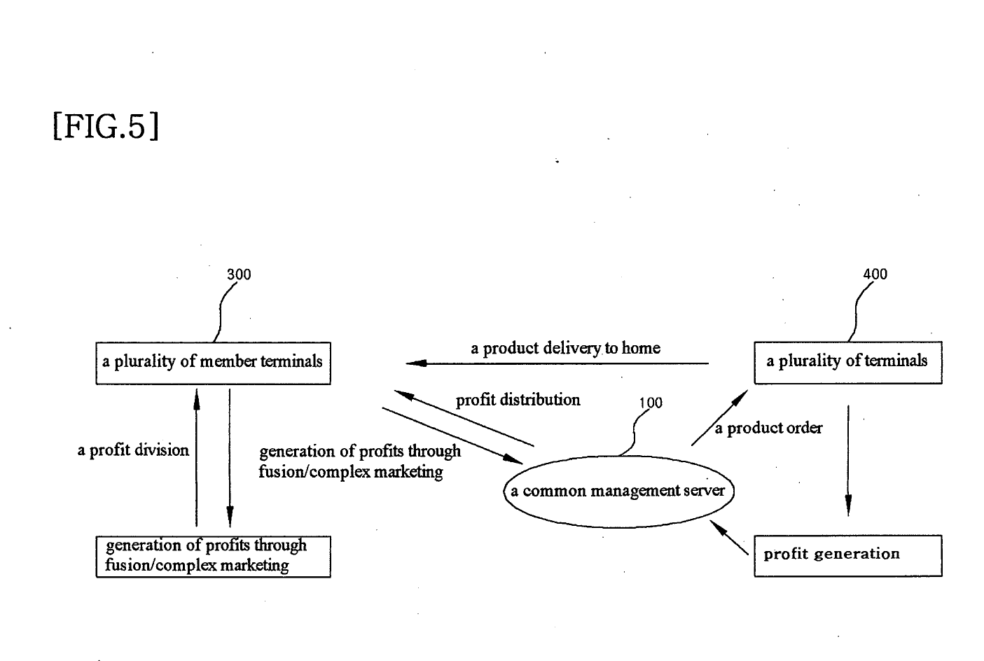

FIG. 4 is a sales flow chart illustrating a common purchase method having circular membership system for congratulation and condolence according to an embodiment of the present invention. FIG. 5 is a diagram explaining the operation processes of a common purchase system and its method having circular membership system for congratulation and condolence according to an embodiment of the present invention.

Referring to FIG. 4, according to a common purchase method having circular membership system for congratulation and condolence according to an embodiment of the present invention, new members should be invited as a beneficiary as the admission precondition of the congratulation and condolence membership, and establishes a membership network structure 10 in a membership management unit 120 as illustrated in FIG. 2 (step S100). Thereafter, according to the established membership network structure 10, a process for generating a member information of each member and storing it in the storage unit 130 of member information is executed like FIG. 3 (step S200). The members can buy the goods of the cooperative enterprises posted in the cooperative purchase management unit 140 via the communication network 200 so that the sales profit can be generated, and the scores corresponding to the purchase amount are accumulated in the storage unit 130 of member information for the members who buy the goods (step S300). On every settlement date, monthly sales profits are distributed according to the accumulated scores of the members, and the allowances are paid to each of the related upper level members or each of the recommending members stored in the membership information data 20 of each member until frequency of payment reaches 24 times (step S400). When receiving the congratulation and condolence, the members can receive the concerned services by notifying the concerned cooperative enterprises of the congratulation and condolence (step S500).

In the member admission method of the step S100, as previously mentioned with referring to FIG. 2, since the same member can subscribe to the system repeatedly with different identification number, the same member can have many accounts according to the membership network structure 10.

At the step S300, it is desirable for the members to buy the indispensable necessaries continuously by posting the necessaries which the members need in a daily life in the cooperative purchase management unit 140. Further, the above necessaries include only verified products among the products which the registered cooperative enterprises deal with, and the registered cooperative enterprises provide the products ordered or requested from the plurality of member terminals 300 via the common management server 100 directly to the members. That is, since a member directly buys the verified products of the cooperative enterprises via the common management server 100 according to the present invention, a management service which enables many consumer members to buy the daily necessaries commonly by operating while setting a member as a consumer concept.

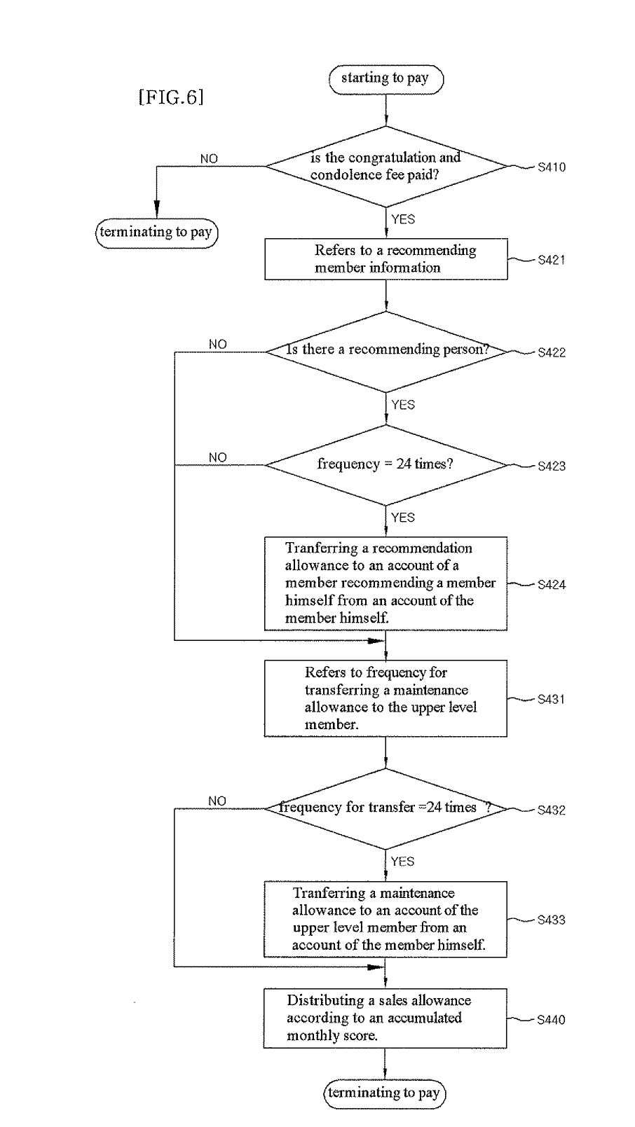

FIG. 6 is a flow chart illustrating a payment method of a sales profit and an allowance in the step S400 according to an embodiment of the present invention.

Referring to FIG. 6, a payment method of a sales profit and an allowance on a settlement date according to the present invention consists of a step S410 for terminating payment if a member himself does not pay the congratulation and condolence fees, and paying a sales profit and an allowance if a member himself have paid the congratulation and condolence fees completely by referring to a payment breakdown 23 of the congratulation and condolence fees of the membership information data 20 after designating a settlement date as a reference; a step for judging (S422) whether the member recommending a member himself exists or not with referring to the recommendation member information 26 (S421), for transferring (S424) a recommendation allowance to an account of a recommending member from the person himself when the number of time of payment is below a designated number of time (24 times in FIG. 5) after checking (S423) frequency of a recommendation allowance paid to the recommending member if there exists the recommending member, and for not transferring (S420) a recommendation allowance to an account of a recommending member from the person himself if the recommending member does not exist; a step for selecting (S432) the upper members who do not pay the maintenance allowance until the designated frequency with referring to (S431) frequency of a maintenance allowance paid to each of the upper members in the information 25 of the upper level member, and for transferring (S433 and S430) the maintenance allowance from the person himself to the account of the upper members; and a step (S440) for distributing a sales allowance according to the accumulated scores of a settlement month with referring to the accumulated monthly scores at the step S300.

In the method the step S430 for transferring the maintenance allowance, if each of the upper members did not recommend other members, it is desirable to deposit only a predetermined ratio of the maintenance allowance drawn from an account of the person himself to the accounts of the upper members. That is, there is an effect that expansion of a membership network can be facilitated by paying more maintenance allowance to the member who recommends other persons and registers them as a membership as compared with the other members who do not recommend other persons.

The present invention is explained and illustrated by taking a specific embodiment as an example for explaining the technological concept, but the present invention is not limited to the operations and structure same as those of the specific embodiment and it is to be understood that various kinds of changes can be employed without deviating from the scope of the present invention. Thus, those changes are considered as the scope of the present invention and the scope of the present invention must be determined by the claims described later.

1. A common purchase system having circular membership system for congratulation and condolence which organizes members as a circular membership system, and buys products desired by the members in a cooperative manner comprising,
a plurality of member terminals 300 for requesting for an application of the congratulations and condolences membership, requesting an application for registration as a beneficiary and requesting cooperative purchase of daily necessaries of life via a communication network;
a plurality of terminals 400 of cooperative enterprises which receives product information for which cooperative purchase is requested in the plurality of member terminals 300, delivers a concerned product, and then provides a delivery result information about the product which is bought according to a cooperative purchase request;
a common management server 100 which responds to a request for registration as a beneficiary and an admission request as a membership of a congratulation and condolence group from the plurality of member terminals, arranges the admitted members according to an admission order by employing membership network structure 10 of a pyramid type in which two lower members are arranged under the upper level member, and registers them as beneficiaries, pays a maintenance allowance corresponding to a designated frequency to the members related to the upper level designated for each member, pays a recommendation allowance corresponding to a designated frequency to recommendation members, generates sales profit by enabling the members to buy the goods of the cooperative enterprises together and then distributes the generated sales profit to each member according to purchase accomplishments obtained based on the delivery result information outputted from plurality of terminals of cooperative enterprises, and notifies the concerned cooperative enterprises of congratulation and condolence of the members when they are received; and
a communication network 200 connecting the common management server 100, the plurality of member terminals 300, and the plurality of terminals 400 of cooperative enterprises

2. The common purchase system having circular membership system for congratulation and condolence set forth in the claim 1, wherein in the common management server 100, each member can be registered in the system while maintaining many accounts under a condition that one account is designated as a minimum unit, and one account is divided into 10 scores, and one score becomes a profit obtained by consumption, that is, 1,000 won.

3. The common purchase system having circular membership system for congratulation and condolence set forth in the claim 1, wherein the common management server 100 comprising,
a storage unit 130 of member information stores a membership information data 20 for each member which consists of an identification number 21 of a registered member, a member admission information 22, a payment breakdown 23 of congratulation and condolence fees, an accumulated monthly score 24 obtained when a member buys the goods, a piece of information 25 of the upper level member about concerned members included in the range of the upper level designated as information about the upper level member of the member, and a recommendation member information 26 about a member who recommended admission of the member;
a membership management unit 120 which is a membership network structure 10 of a pyramid type in which two lower members are arranged under one upper level member, forms a membership network structure 10 by arranging the subscribed members sequentially in a lower echelon of the membership network structure 10 of a pyramid type according to an admission order, issues an identification number to a new member if an admission request of the new member is made, stores the identification numbers of the members arranged until a designated upper level among the upper members related to the new member, and an identification number of the member who recommended the newly subscribed member in a membership information data 20 corresponding to the newly subscribed member, stores an identification number of a recommending member in the membership information data 20 of the recommended member, and notifies the concerned cooperative enterprises of congratulation and condolence of the members when they are received from the plurality of member terminals 300;
a cooperative purchase management unit 140 which provides information about the goods which are to be sold to the members to the members, provides a purchasing information including the purchasing commodities, the quantity, and the addresses of the members who requested purchase of commodity according to the purchase request of a member to the terminals 400 of the concerned cooperative enterprises, checks settlement of prices according to purchasing of the goods, and stores amount of the purchased goods and a score alloted to the quantity in the membership information data 20 of a member who bought the goods;
an allowance management unit 150 which pays a maintenance allowance on a settlement date to the upper level member corresponding to each member until a predetermined frequency only with respect to the members who pay the congratulation and condolence fees with referring to each of the membership information data 20 stored in storage unit 130 of member information, pays a recommendation compensation to a recommending member of each members until a designated frequency, and pays sales allowance to each member according to the accumulated monthly scores of each member; and
a central control unit 110 which transmits the received admission information to the membership management unit 120 if a membership admission is requested so that a membership network structure can be organized, stores information of each member in the storage unit 130 of member information according to the organized membership network structure 10, transmits a piece of purchase information to the cooperative purchase management unit 140 if purchase of the goods is requested by a member so that the member can buy the desired goods from the cooperative enterprises, and enables settlement of the allowance management unit to be performed via a communication network.

4. The common purchase system having circular membership system for congratulation and condolence set forth in the claim 1, wherein the allowance management unit 150 limits frequency of a maintenance allowance and a recommendation allowance payment paid to upper level members.

5. In a common purchase system having circular membership system for congratulation and condolence which organizes members as a circular membership system and buys products desired by the members in a cooperative manner,
a common purchase method having circular membership system for congratulation and condolence comprising a plurality of member terminals 300 for requesting for an application of the congratulations and condolences membership, requesting an application for registration as a beneficiary and requesting cooperative purchase of daily necessaries of life via a communication network; a plurality of terminals 400 of cooperative enterprises which receives product information for which cooperative purchase is requested in the plurality of member terminals 300, delivers a concerned product, and then provides a delivery result information about the product which is bought according to a cooperative purchase request; and a common management server 100 which responds to a request for registration as a beneficiary and an admission request as a membership of a congratulation and condolence group from the plurality of member terminals, arranges the admitted members according to an admission order by employing membership network structure 10 of a pyramid type in which two lower members are arranged under the upper level member, and pays a maintenance allowance corresponding to a designated frequency to the members related to the upper level designated for each member, pays a recommendation allowance corresponding to a frequency to recommendation members, generates sales profit by enabling the members to buy the goods of the cooperative enterprises together and then distributes the generated sales profit to each member according to purchase accomplishments obtained based on the delivery result information outputted from plurality of terminals of cooperative enterprises 400, and notifies the concerned cooperative enterprises of congratulation and condolence of the members when they are received, is characterized in that it comprises,
a step S100 for collecting members as a beneficiary as a precondition of admission and for establishing a membership network by associating members ranging from the upper level to a lower level according to an admission order;
a step S200 for creating a membership information data including information of associated members or recommending members from the established membership network to a designated level;
a step S300 for generating a sales profit by enabling members to buy the products requested by the members via the cooperative enterprises, and accumulating scores corresponding to a purchase amount for a member who bought the products;
a step S400 for distributing the generated sales profit to the members according to the accumulated scores and for paying an allowance to the associated members or the recommending members stored in the member information database of each member; and
a step S500 for notifying concerned cooperative enterprises of congratulation and condolence related to the members when they are received.

6. The common purchase method having circular membership system for congratulation and condolence set forth in the claim 5, wherein said step S100 organizes the membership network structure 10 in which two lower members are associated to one upper level member, and arranges a new member at a next position of last position of the lowest level.

7. The common purchase method having circular membership system for congratulation and condolence set forth in the claim 5, wherein the membership information data 20 of the step S200 is characterized in that it comprises an identification number 21 of a registered member; a payment breakdown 23 of fees of congratulation and condolence; a piece of information 25 of the upper level member about associated members included in the range of the upper level designated as information about the upper level member of the member; and a recommendation member information 26 about a member who recommended an admission of the member.

8. The common purchase method having circular membership system for congratulation and condolence set forth in the claim 5, wherein said step S400 is characterized in that is comprises,
a step S410 for terminating payment if a member himself does not pay the congratulation and condolence fees, and for starting to pay a sales profit and an allowance if a member himself have paid the congratulation and condolence fees completely;
a step S420 for transferring a recommendation allowance to an account of a recommending member who recommends the member from the member's account until a predetermined frequency;
a step S430 for transferring a maintenance allowance from the member's account to associated members up to a designated level account among the upper members of the member until a predetermined frequency; and
a step (S440) for distributing a sales allowance according to an accumulated score of each member at the step S300.

9. The common purchase method having circular membership system for congratulation and condolence set forth in the claim 8, wherein at the said step S430, if the upper level member who receive an maintenance allowance did not recommend other members, only amount of money of a predetermined ratio of drawn maintenance allowance is deposited in an account of the upper level member.

10. The common purchase method having circular membership system for congratulation and condolence set forth in the claim 5, wherein it is characterized in that a same person can many accounts by filing an admission application repeatedly using many identification numbers.
